(19) United States
(12) Patent Application Publication
(10) Pub. No.: US 2026/0274274 A1
(43) Pub. Date: Sep. 17, 2026

(54) VEHICLE CONTROL DEVICE

(71) Applicant: HONDA MOTOR CO., LTD., Tokyo (JP)

(72) Inventors: Masaki MORIKAWA, Tokyo (JP); Noriaki SUZUKI, Tokyo (JP); Kazuya SAKURAI, Tokyo (JP)

(21) Appl. No.: 19/449,417

(22) Filed: Jan. 15, 2026

(30) Foreign Application Priority Data
Mar. 17, 2025 (CN) 202510311741.X

(51) Int. Cl. B60W 50/00; B60W 30/18; B60W 30/182

(52) U.S. Cl. CPC B60W 50/0098; B60W 30/18018; B60W 30/18063; B60W 30/182

(57) ABSTRACT

Provided is a vehicle control device that makes it possible to prevent a host vehicle from performing an unintentional motion caused by a change in the settings of the vehicle. A vehicle control device 1 includes a driving source 2 configured to drive a vehicle and a brake hold function of holding braking force to keep the vehicle in a stopped state. The vehicle has a plurality of changeable drive patterns. The brake hold function is executed when the drive pattern is changed while the vehicle is in the stopped state.

This application is based on and claims the benefit of priority from Chinese Patent Application No. CN 202510311741.X, filed on 17 Mar. 2025, the content of which is incorporated herein by reference.

### BACKGROUND OF THE INVENTION

### Field of the Invention

The present invention relates to a vehicle control device.

### Related Art

Technology that keeps a vehicle in a stopped state is known as an aspect of brake assist for a vehicle. In relation to keeping a vehicle in the stopped state, Japanese Patent No. 6849575 discloses technology that does not release the stopped state of a host vehicle in a case where it is determined to be desirable to keep the host vehicle stopped on the basis of a condition of the area around the host vehicle.

Patent Document 1: Japanese Patent No. 6849575.

### SUMMARY OF THE INVENTION

The technology disclosed in Japanese Patent No. 6849575, however, stops releasing the stopped state of the host vehicle and continues the stopped state depending on the condition around the host vehicle such as the environment of the road or the status of other vehicles. In this way, the conventional vehicle control device has not taken anything into consideration to prevent the host vehicle from performing an unintentional motion caused by a change in the settings of the vehicle such as a change in the drive pattern.

The present invention has been made in view of the problem described above, and an object of the present invention is to provide a vehicle control device capable of preventing a host vehicle from performing an unintentional motion caused by a change in the settings of the vehicle to thereby increase the safety of the vehicle. Moreover, the present invention improves traffic safety still more to contribute to the development of a sustainable transportation system.

(1) A vehicle control device according to the present invention includes: a driving source configured to drive a vehicle; and a brake hold function of holding braking force to keep the vehicle in a stopped state. The vehicle has a plurality of changeable drive patterns. The vehicle control device executes the brake hold function when the drive pattern is changed while the vehicle is in the stopped state.

The vehicle control device described above makes it possible to prevent a host vehicle from performing a movement unintended by a driver when the drive pattern of the vehicle is changed.

(2) In the vehicle control device, the drive patterns may include a first drive pattern having a one-pedal function of controlling driving force and the braking force of the vehicle using a single pedal, and a second drive pattern having a two-pedal function of controlling the driving force and the braking force of the vehicle using respective pedals. The vehicle control device may execute the brake hold function when the first drive pattern is changed to the second drive pattern while the vehicle is in the stopped state.

The vehicle control device described above makes it possible to restrain a vehicle from performing a movement unintended by a driver because the vehicle is kept in the stopped state in spite of switching to a two-pedal mode in the stopped state of the vehicle in which the driver's foot is off the pedal at the time of a one-pedal mode.

(3) In the vehicle control device, the first drive pattern may hold the stopped state with no operation made by a driver on the pedal. The second drive pattern may make the vehicle creep forward or backward with no operations made by the driver on the pedals.

The vehicle control device described above makes it possible to restrain a vehicle from performing a movement unintended by a driver because the vehicle is kept in the stopped state in spite of switching to a two-pedal mode in the stopped state of the vehicle in which the driver's foot is off the pedal at the time of a one-pedal mode.

(4) In the vehicle control device, the vehicle may include a plurality of drive modes, and switching between the plurality of drive modes during the first drive pattern may cause a change to the second drive pattern.

The vehicle control device described above makes it possible to restrain a vehicle from performing a movement unintended by a driver because the vehicle is kept in the stopped state in spite of an unintentional change to a two-pedal mode made by the driver switching the drive mode when the vehicle is kept in the stopped state with the driver's foot off the pedal at the time of a one-pedal mode.

(5) In the vehicle control device, switching from a predetermined drive mode to a sport drive mode during first drive pattern may cause a change to the second drive pattern.

Conventionally speaking, when a change to a two-pedal mode is made by a driver switching to a sport mode while the vehicle is in the stopped state (brake hold state) in which the driver's foot is off the pedal in a one-pedal mode, the vehicle unintentionally starts to move in some cases because the driver's foot remains off.

With respect to this, the vehicle control device described above makes it possible to restrain the vehicle from performing a movement unintended by the driver because the vehicle is kept in the stopped state.

The present invention makes it possible to provide a vehicle control device capable of preventing a host vehicle from performing an unintentional motion caused by a change in the settings of the vehicle to thereby increase the safety of the vehicle.

### BRIEF DESCRIPTION OF THE DRAWINGS

FIG. 1 is a diagram illustrating a schematic configuration of a vehicle control device according to an embodiment of the present invention; and

FIG. 2 is a flowchart illustrating an example of a flow of processing by the vehicle control device according to the embodiment of the present invention.

### DETAILED DESCRIPTION OF THE INVENTION

Hereinafter, a vehicle control device according to an embodiment of the present invention will be specifically described with reference to the drawings. The vehicle control device according to the present embodiment includes a brake hold function. The brake hold function is a function of holding braking force for a vehicle to keep the vehicle in a stopped state.

In addition, the vehicle control device according to the present embodiment has a plurality of drive patterns. Each of the drive patterns is an operation pattern that is decided by the manner or the like in which a driver operates an operating element or the like to drive a vehicle and pertains, for example, to driving and stopping the vehicle.

One of two drive patterns of the plurality of drive patterns is defined as a first drive pattern and the other is defined as a second drive pattern.

The first drive pattern is a drive pattern for accelerating and decelerating a vehicle using one operating element. The first drive pattern is also referred to as a single-pedal (one-pedal) mode. The one operating element used in the first drive pattern is referred to as a single acceleration-deceleration operating element. The acceleration-deceleration operating element is also referred to as an acceleration-deceleration pedal.

In this way, the first drive pattern is a drive pattern having a one-pedal function of controlling the driving force and the braking force of the vehicle using a single pedal.

The second drive pattern is a drive pattern for accelerating and decelerating a vehicle using two operating elements. The second drive pattern is also referred to as a two-pedal mode. The two operating elements used in the second drive pattern are referred to as an accelerator operating element and a brake operating element. The accelerator operating element is also referred to as an accelerator pedal. The brake operating element is also referred to as a brake pedal.

In this way, the second drive pattern is a drive pattern having a two-pedal function of controlling the driving force and the braking force of the vehicle using respective pedals.

It is possible to use the acceleration-deceleration pedal in the first drive pattern as the accelerator pedal in the second drive pattern. In other words, it is possible to cause one operating element to serve as the acceleration-deceleration operating element and the accelerator operating element.

It is possible to switch the drive pattern by a driver operating a drive pattern selection switch. The drive pattern selection switch will be described below.

The vehicle control device includes a plurality of drive modes. The drive modes are vehicle control patterns for comprehensively changing a driver's driving feeling, vehicle fuel consumption efficiency, and an applied traffic situation (such as traffic congestion or high-speed cruising). For example, settings such as the manner of shifting gears, the suspension stiffness, and the steering feeling of a steering wheel are changed by changing the drive mode. Examples of the drive modes include an eco/NORMAL mode and an S (sport) mode.

It is possible to switch the drive mode by a driver operating a drive mode selection switch. The drive mode selection switch will be described below.

In addition, the vehicle control device may include a plurality of shift modes. The shift modes refer to patterns, for example, for switching the low-speed gears. The vehicle control device may include, for example, a fixed shift mode and a smart shift mode. The fixed shift mode is a shift mode that allows a plurality of low-speed gears to be switched on the basis of an operation of a driver. The smart shift mode is a shift mode that allows a plurality of low-speed gears to be switched on the basis of the drive state of the vehicle. The smart shift mode is also referred to as an automatic shift mode.

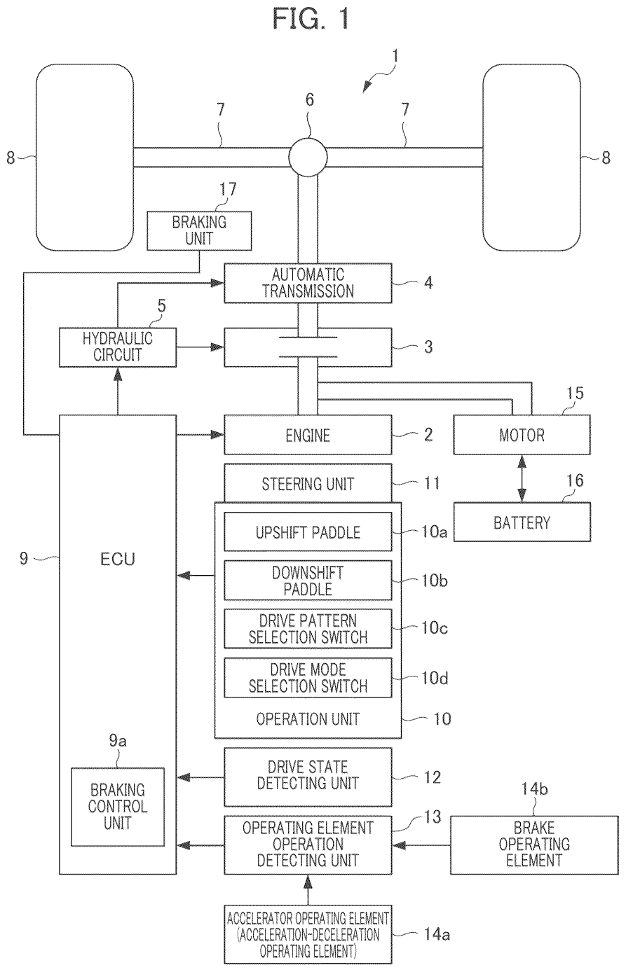

The configuration of a vehicle control device 1 according to an embodiment of the present invention will be described using FIG. 1. FIG. 1 is a diagram illustrating the schematic configuration of the vehicle control device 1 according to the embodiment of the present invention.

As illustrated in FIG. 1, the vehicle control device 1 includes an engine 2, a clutch 3, an automatic transmission 4, a hydraulic circuit 5, a differential mechanism 6, a pair of left and right drive axles 7, a pair of left and right driving wheels 8, an ECU (Electric Control Unit) 9, an operation unit 10, a steering unit 11, a drive state detecting unit 12, an operating element operation detecting unit 13, an accelerator operating element 14a, a brake operating element 14b, a motor 15, a battery 16, a braking unit 17, and the like. The engine 2 is a power source. The automatic transmission 4 functions as a speed reduction unit. The operation unit 10 includes an upshift paddle 10a and a downshift paddle 10b. The operation unit 10 functions as a shift device or a paddle shifter.

The engine 2 is a power source that generates power for the vehicle. That is, the engine 2 is a driving source. The present embodiment adopts an electric motor as a driving source in addition to the engine 2. Specifically, the present embodiment adopts a hybrid engine combined with the motor 15. Power generated by the hybrid engine is transmitted to the pair of left and right drive axles 7 through the clutch 3, the automatic transmission 4, and the differential mechanism 6. The pair of left and right driving wheels 8 is attached to the pair of left and right drive axles 7.

The clutch 3 disconnects the transmission path of power generated by the hybrid engine and transmitted to the pair of left and right drive axles 7 depending on pressure caused by hydraulic oil supplied from the hydraulic circuit 5, that is, hydraulic pressure.

The automatic transmission 4 adjusts the gear ratio depending on the pressure caused by the hydraulic oil supplied from the hydraulic circuit 5.

The hydraulic circuit 5 supplies the clutch 3 and the automatic transmission 4 with the pressure of the hydraulic oil on the basis of the control of the ECU 9.

The differential mechanism 6 distributes, to the pair of left and right drive axles 7, power generated by the hybrid engine and transmitted through the clutch 3 and the automatic transmission 4. The pair of left and right driving wheels 8 is respectively attached to the pair of left and right drive axles 7. The pair of left and right driving wheels 8 converts power transmitted through the pair of left and right drive axles 7 to propulsive force for the vehicle.

The braking unit 17 is a portion that brakes the vehicle. Braking includes, for example, decelerating, stopping the vehicle, keeping the vehicle stopped, and the like.

The ECU 9 controls the engine 2, the motor 15, the battery 16, the hydraulic circuit 5, and the like on the basis of inputs from the operation unit 10, the drive state detecting unit 12, the operating element operation detecting unit 13, and the like. This ECU 9 reads and executes computer programs stored in a memory (not illustrated) included in the ECU 9, thereby carrying out various kinds of processing.

The ECU 9 includes a braking control unit 9a. The braking control unit 9a controls the braking unit 17 and controls the braking status of the vehicle.

As described above, the vehicle control device 1 includes the brake hold function. This brake hold function may be achieved by the braking control unit 9a controlling the braking unit 17.

The ECU 9 and the motor 15 are included in the speed reduction unit according to the present embodiment. The speed reduction unit according to the present embodiment includes a plurality of low-speed gears that allows the deceleration of the vehicle to be changed.

The motor 15 generates driving force when a driver steps on the accelerator operating element 14a, that is, an accelerator pedal, for acceleration. Meanwhile, when the driver takes a foot off the accelerator operating element 14a for deceleration, the counterforce works and the motor 15 serves as an electricity generator. This force necessary to generate electricity serves as resistance to the rotation of the driving wheels 8 and functions as a regenerative brake. The speed reduction unit according to the present embodiment thus controls the rotation of the motor 15 using the ECU 9, thereby allowing the force of this regenerative brake to be divided into some levels and changed. Specifically, the speed reduction unit according to the present embodiment allows the deceleration of the vehicle to be changed in some levels depending on operations of a driver on the upshift paddle 10a and the downshift paddle 10b called deceleration selectors described below.

The brake operating element 14b is operated to adjust braking force in the two-pedal mode described above.

The operation unit 10 is provided on the steering unit 11. The operation unit 10 may be configured to allow the drive pattern or the drive mode to be selected and switched depending on an operation of a driver. In addition, the drive pattern or the drive mode may be configured to be selectable and switchable by another device other than the operation unit 10. Hereinafter, a configuration example of the operation unit 10 will be described.

The operation unit 10 is a shift device that allows a plurality of low-speed gears to be changed. The operation unit 10 that is a shift device includes the upshift paddle 10a serving as a first operation unit and the downshift paddle 10b serving as a second operation unit. The upshift paddle 10a allows the currently selected low-speed gear to be switched to a low-speed gear the deceleration of which is less than the deceleration of the currently selected low-speed gear. The downshift paddle 10b allows the currently selected low-speed gear to be switched to a low-speed gear the deceleration of which is greater than the deceleration of the currently selected low-speed gear.

The operation unit 10 further includes a drive pattern selection switch 10c. The drive pattern selection switch 10c is a switch for a driver to switch the drive pattern. The drive pattern selection switch 10c is provided, for example, on a steering wheel serving as the steering unit 11. Note that the position at which the drive pattern selection switch 10c is included is not limited to the steering wheel or the like. In addition, the form of the drive pattern selection switch 10c is not also limited in particular as long as it is possible to switch the drive pattern.

The operation unit 10 further includes a drive mode selection switch 10d. The drive mode selection switch 10d is a switch for a driver to switch the drive mode. The drive mode selection switch 10d is provided, for example, on the steering wheel serving as the steering unit 11. Note that the position at which the drive mode selection switch 10d is included is not limited to the steering wheel or the like as with the drive pattern selection switch 10c. In addition, the form of the drive mode selection switch 10d is not also limited in particular as long as it is possible to switch the drive mode.

The drive state detecting unit 12 detects the drive state of the vehicle. For the detected drive state of the vehicle, this drive state detecting unit 12 inputs a detection signal thereof to the ECU 9.

The operating element operation detecting unit 13 detects the operation statuses of the accelerator operating element 14a and the brake operating element 14b. As described below, in a case where the accelerator operating element 14a is functioning as an acceleration-deceleration operating element, the operation status of the acceleration-deceleration operating element is detected. The operating element operation detecting unit 13 inputs the detected operation status of the operating element to the ECU 9.

The motor 15 is rotated by the power of the engine 2 to generate electricity. Meanwhile, the motor 15 also serves as a power source that generates power for the vehicle using the electricity of the battery 16.

The battery 16 is charged with electricity generated by the motor 15.

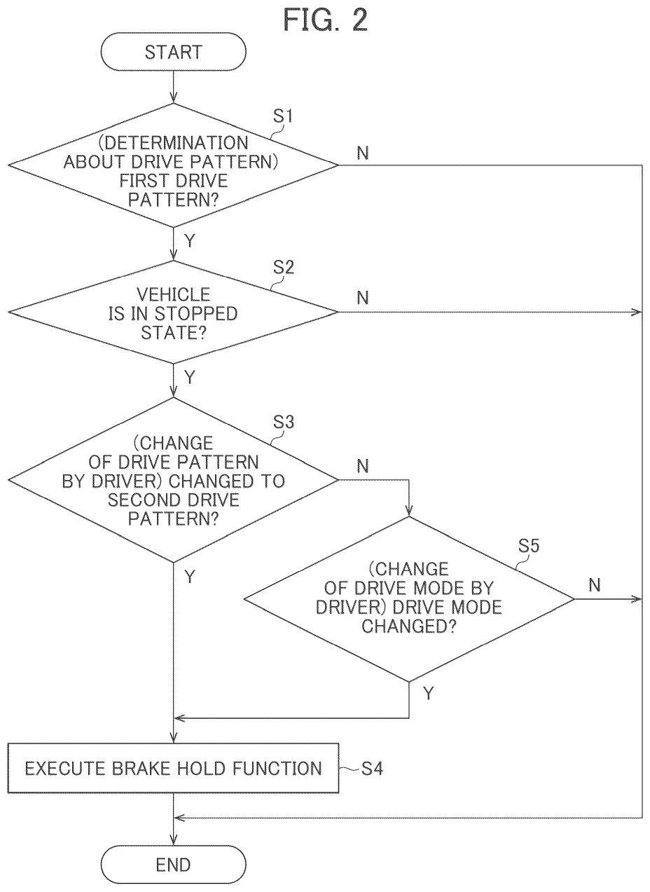

The brake hold function according to the present embodiment will be described with reference to FIG. 2 in addition to FIG. 1. FIG. 2 is a flowchart illustrating an example of the flow of processing by the vehicle control device 1 according to the present embodiment.

As described above, the vehicle control device 1 includes the brake hold function. Hereinafter, a scene in which the brake hold function is executed will be described.

### Change of Drive Pattern

It is possible to execute the brake hold function, for example, when a driver changes the drive pattern in a case where the vehicle is in the stopped state. In a case where the vehicle includes a plurality of drive states, the driver changes the drive pattern in some cases in a state in which the vehicle is stopped. In addition, some drive patterns assign different functions to an operating element such as a pedal.

In a case where the drive pattern is changed for a host vehicle in the stopped state, the vehicle performs a movement unintended by a driver in some cases. For example, in a case where a drive pattern in which a vehicle is kept in the stopped state in spite of a foot of a driver being off a pedal is changed to a drive pattern in which a driver has to step on a pedal to keep a vehicle in the stopped state, it is possible that the vehicle moves without the driver's intent.

The vehicle control device 1 according to the present embodiment executes the brake hold function when the drive pattern is changed in a case where the vehicle is in the stopped state. It is therefore possible to restrain the vehicle from performing a movement unintended by the driver even though a foot of the driver is off the pedal in the example described above.

In addition, the vehicle control device 1 according to the present embodiment executes the brake hold function, for example, depending on a change of the drive pattern made by the driver, that is, a change in the status of the host vehicle. It is therefore possible to keep the stopped state regardless of the environment around the host vehicle.

### Change from First Drive Pattern to Second Drive Pattern

The brake hold function executed by changing the drive pattern will be described. In a case where the drive pattern is the first drive pattern and the vehicle is stopped, the brake hold function may be executed when the drive pattern is changed from the first drive pattern to the second drive pattern.

As described above, the first drive pattern is a drive pattern having the one-pedal function of controlling the driving force and the braking force of the vehicle using a single pedal. In addition, the second drive pattern is a drive pattern having the two-pedal function of controlling the driving force and the braking force of the vehicle using respective pedals.

In a case where the one-pedal function is enabled in the first drive pattern, the vehicle is kept in the stopped state even though a driver takes a foot off the pedal. In contrast, in a case where the two-pedal function is enabled, the vehicle normally moves when a driver takes a foot off the pedal.

Therefore, the vehicle may perform a movement unintended by the driver in a case where the drive pattern is changed to the second drive pattern when the vehicle is stopped in the first drive pattern.

In a case where the drive pattern is the first drive pattern and the vehicle is stopped, the vehicle control device 1 according to the present embodiment executes the brake hold function when the drive pattern is changed from the first drive pattern to the second drive pattern. The vehicle is therefore kept in the stopped state even though the two-pedal mode is switched on in the stopped state of the vehicle in which a foot is off the pedal at the time of the one-pedal mode. As a result, it is possible to restrain the vehicle from performing a movement unintended by the driver.

A typical specific example will be described. It is assumed that the first drive pattern is a drive pattern in which the stopped state is held with no operation made by an occupant, that is, a driver, on the pedal. Meanwhile, it is assumed that the second drive pattern is a drive pattern in which the vehicle creeps forward or backward with no operations made by the driver on the pedals.

The control device 1 according to the present embodiment keeps even such a vehicle in the stopped state even though the two-pedal mode by the second drive pattern is switched on in the stopped state of the vehicle in which a foot is off the pedal at the time of the one-pedal mode by the first drive pattern. As a result, it is possible to restrain the vehicle from performing a movement unintended by the driver.

That is, the control device 1 according to the present embodiment makes it possible to restrain the vehicle from moving by executing the brake hold function even though the two-pedal mode is switched on in the stopped state of the vehicle in which a foot is off the pedal at the time of the one-pedal mode.

The flow of the processing will be described with reference to FIG. 2. S1 means step 1 in FIG. 2 and the following description. The same applies to S2 and the like

### S1

S1 is a step of determining the drive pattern. In S1, it is determined whether the drive pattern is the first drive pattern. In a case where the drive pattern is the first drive pattern, the determination results in YES, that is, Y. The step advances to S2. In a case where the drive pattern is not the first drive pattern, the determination results in NO, that is, N. The processing comes to an end.

### S2

S2 is a step of determining whether the vehicle is in the stopped state. In a case where the vehicle is in the stopped state, the determination results in Y. The processing advances to S3. In a case where the vehicle is not in the stopped state, the determination results in N. The processing comes to an end.

### S3

S3 is a step of determining whether the driver changes the drive pattern. In a case where the processing advances to S3, the drive pattern is the first drive pattern. Accordingly, it is determined in S3 whether the drive pattern is changed to the second drive pattern.

In a case where the change to the second drive pattern is made, the determination results in Y. The processing advances to S4. In a case where the change to the second drive pattern is not made, the determination results in N. The processing advances to S5. S5 will be described below. In addition, in a case where the determination in S3 is N, it is also possible to bring the processing to an end.

### S4

S4 is a step of executing the brake hold function. In S4, the brake hold function is executed and braking force is held to keep the vehicle in the stopped state. This makes it possible to prevent the vehicle from performing a movement unintended by the driver. In S4, the processing comes to an end.

### Switch Between Drive Modes

In a case where the drive mode is switched when the drive pattern is the first drive pattern, the control device 1 according to the present embodiment may change the drive pattern from the first drive pattern to the second drive pattern.

In a case where the vehicle includes, for example, the eco/NORMAL mode and the S (sport) mode as drive modes, switching the drive mode includes switching from eco/NORMAL to the S mode, switching from the S mode to eco/NORMAL, switching to a mode in which eco/NORMAL and the S mode are alternately switched as appropriate, and the like.

In a case where the drive mode is switched in the first drive pattern, the control device 1 according to the present embodiment changes the drive pattern to the second drive pattern. The change to the second drive pattern switches the state in which the one-pedal function is enabled to the state in which the two-pedal function is enabled.

When changing the drive mode, it is desired to prevent the driver from erroneously recognizing a function or the like assigned to an operating element after the change. In a case where the drive mode is switched in the first drive pattern, the control device 1 according to the present embodiment changes the drive pattern to the second drive pattern. That is, the one-pedal mode in the first drive pattern is switched to the two-pedal mode in the second drive pattern. The two-pedal mode is a mode that is normally adopted by a vehicle. That is, the two-pedal mode is a widely familiar mode. In addition, in the two-pedal mode, the brake operating element 14b is enabled.

This makes it possible to restrain the driver from erroneously recognizing the operating elements when the drive mode is changed. In addition, the brake operating element 14b is enabled, thereby making it possible to increase the safety.

However, in the second drive pattern, the vehicle normally creeps forward or backward with no operations made by the driver on the pedals. With respect to this, the control device 1 according to the present embodiment executes the brake hold function in a case where the drive mode is changed. Even in a case where the change of the drive mode switches the drive pattern to the second drive pattern, it is therefore possible to restrain the vehicle from performing a movement unintended by the driver.

### S5

S5 of the flow of the processing illustrated in FIG. 2 corresponds to this step. S5 is a step of determining whether the driver changes the drive mode. In a case where the drive mode is changed, the determination results in Y. The step advances to S4. In S4, the brake hold function is executed. In a case where the drive mode is not changed, the determination results in N. The processing comes to an end.

As described above, the vehicle control device 1 according to the present embodiment makes it possible to restrain the vehicle from performing a movement unintended by a driver because the vehicle is kept in the stopped state in spite of an unintentional change to the two-pedal mode made by the driver switching the drive mode when the vehicle is kept in the stopped state with a foot off the pedal at the time of the one-pedal mode.

The change of the drive pattern to the second drive pattern made by switching the drive mode as described above makes it possible to change the drive pattern to the second drive pattern in particular when the normal drive mode is switched to the sport drive mode.

In a case where the eco/NORMAL mode and the S mode are included as described above, the normal drive mode corresponds to the eco/NORMAL mode and the sport drive mode corresponds to the S mode.

Drivers who change the drive mode to the S mode prefer the two-pedal mode to the one-pedal mode in the S mode after the change in many cases. This is because agile driving is easier to execute in the two-pedal mode.

When a change to the two-pedal mode is made by a driver switching on the sport mode in the stopped state of a conventional vehicle in which a foot is off the pedal at the time of the one-pedal mode, that is, the brake hold state, the vehicle unintentionally starts to move in some cases because the foot of the driver remains off the pedal. In contrast, the control device 1 according to the present embodiment keeps the vehicle in the stopped state because the brake hold function is executed. As a result, it is possible to restrain the vehicle from performing a movement unintended by the driver.

As described above, in addition to specifications that a one-pedal control function is turned off in a case where such a function that causes control interference is started while the one-pedal control function is in operation, the control device 1 according to the present embodiment continues stop control in a case where the vehicle starts to move without a driver's intent.

Note that the present invention is not limited to the embodiment. The present invention includes modifications, improvements, and the like within the range that allows the object of the present invention to be achieved.

### Explanation of Reference Numerals

1 control device
2 engine (power source, driving source)
3 clutch
4 automatic transmission
5 hydraulic circuit
6 differential mechanism
7 drive axle
8 driving wheel
9 ECU (speed reduction unit)
9a braking control unit
10 operation unit (shift device, paddle shifter)
10a upshift paddle (first operation unit)
10b downshift paddle (second operation unit)
10c drive pattern selection switch
11 steering unit
12 drive state detecting unit
13 operating element operation detecting unit
14a accelerator operating element
14b brake operating element
15 motor (electric motor, electricity generator, speed reduction unit)
16 battery

What is claimed is:

1. A vehicle control device, comprising:
a driving source configured to drive a vehicle; and
a brake hold function of holding braking force to keep the vehicle in a stopped state, wherein
the vehicle has a plurality of changeable drive patterns, and the vehicle control device executes the brake hold function when the drive pattern is changed while the vehicle is in the stopped state.

2. The vehicle control device according to claim 1, wherein the drive patterns include
a first drive pattern having a one-pedal function of controlling driving force and the braking force of the vehicle using a single pedal, and
a second drive pattern having a two-pedal function of controlling the driving force and the braking force of the vehicle using respective pedals, and
the vehicle control device executes the brake hold function when the first drive pattern is changed to the second drive pattern while the vehicle is in the stopped state.

3. The vehicle control device according to claim 2, wherein the first drive pattern holds the stopped state with no operation made by a driver on the pedal, and
the second drive pattern makes the vehicle creep forward or backward with no operations made by the driver on the pedals.

4. The vehicle control device according to claim 2, wherein the vehicle includes a plurality of drive modes, and
switching between the plurality of drive modes during the first drive pattern causes a change to the second drive pattern.

5. The vehicle control device according to claim 3, wherein switching from a predetermined drive mode to a sport drive mode during the first drive pattern causes a change to the second drive pattern.
